(19) United States
(12) Patent Application Publication
(10) Pub. No.: US 2019/0008326 A1
(43) Pub. Date: Jan. 10, 2019

(54) FOOD MACHINE WITH FOOD PROCESSOR TOOLS AND AUTOMATED SHARPENING ALERT AND TRACKING SYSTEM

(71) Applicant: ILLINOIS TOOL WORKS INC., Glenview, IL (US)

(72) Inventor: Ruben T. Huerta-Ochoa, Troy, OH (US)

(21) Appl. No.: 16/025,019

(22) Filed: Jul. 2, 2018

Related U.S. Application Data
(60) Provisional application No. 62/528,603, filed on Jul. 5, 2017.

(51) Int. Cl. A47J 43/07; B24B 3/46

(52) U.S. Cl. CPC A47J 43/0705; A47J 43/255; B24B 3/463

(57) ABSTRACT

A food processing machine includes a head extending over a bowl receiving location, the head including an output shaft driven in a planetary manner. A food processing assembly is mounted below the head and includes a drive assembly for converting planetary motion of the output shaft to a rotational motion of a food processing tool drive shaft about a stationary shaft axis. The food processing assembly includes a food processing tool that can be removed.

### TECHNICAL FIELD

This application relates generally to commercial food processing machines such as mixing machines of the type used to mix food products and, more specifically, to a food machine with automated alerts for needed sharpening and/or tracking of sharpening operations.

### BACKGROUND

Food processing machines incorporate an electric motor, a transmission system, a frame, a food processing plate or set of plates. During the course of operation, a food machine processing plate loses sharpness and its food processing performance decreases, resulting in increased power consumption, increased human effort to perform food processing function, and reduction of quality of processed food product.

Accordingly, it would be desirable to provide a food machine with a system capable of maintaining adequate sharpness of such plates.

### SUMMARY

In one aspect, a food processing machine includes a head extending over a bowl receiving location, the head including an output shaft driven in a planetary manner. A food processing assembly is mounted below the head and includes a drive assembly for converting planetary motion of the output shaft to a rotational motion of a food processing tool drive shaft about a stationary shaft axis. The food processing assembly includes a food processing tool that can be removed.

In one implementation, multiple food processing tools are each removably attachable to the food processing assembly, and a machine controller is configured to track use of different food processing tools on an individual basis and to determine when each food processing tool requires sharpening or honing.

In one implementation, each food processing tool includes an identifier thereon and the machine includes at least one sensor for detecting the identifier.

In one implementation, each identifier comprises an identification code and the sensor is a code reader.

In one implementation, each identification code is one of an RF identification code, a magnetic identification code or an optical identification code and the code reader is one of an RF code reader, a magnetic code reader or an optical code reader.

In one implementation, the controller is configured to determine when each food processing tool requires sharpening or honing.

In one implementation, the controller is configured to determine when each food processing tool requires sharpening or honing based upon one or more of monitored duration of use, number of cycles of use, speed-weighted duration use, or power consumption profile versus a baseline profile.

In one implementation, the machine includes a user interface and the controller is configured to alert a machine operator through the user interface when a given food processing tool requires sharpening or honing.

In one implementation, the controller is configured to determine when one or more food processing tools needs to be replaced.

In one implementation, the controller is configured to determine when each food processing tool requires sharpening or honing based upon comparison of an actual current power consumption profile versus a baseline profile.

In one implementation, the controller is configured to store multiple baseline profiles for at least one food processing tool in memory according to multiple operation types for which the food processing tool is used.

In one implementation, the drive assembly includes a coupler engaged with output shaft to permit the output shaft to rotate freely, wherein the coupler is connected to a crank arm that extends to the food processing tool drive shaft.

In one implementation, the coupler is ring shaped and receives the output shaft therein.

In one implementation, the coupler is formed by a drive surface of the crank arm.

The details of one or more embodiments are set forth in the accompanying drawing and the description below. Other features, objects, and advantages will be apparent from the description and drawing, and from the claims.

### BRIEF DESCRIPTION OF THE DRAWINGS

FIG. 1 is a schematic side elevation of a food mixing machine;

FIG. 2 is a schematic depiction of a food processing system drive assembly;

FIG. 3 is an exemplary load profile graph; and

FIG. 4 is a schematic depiction of another food processing system drive assembly.

### DESCRIPTION

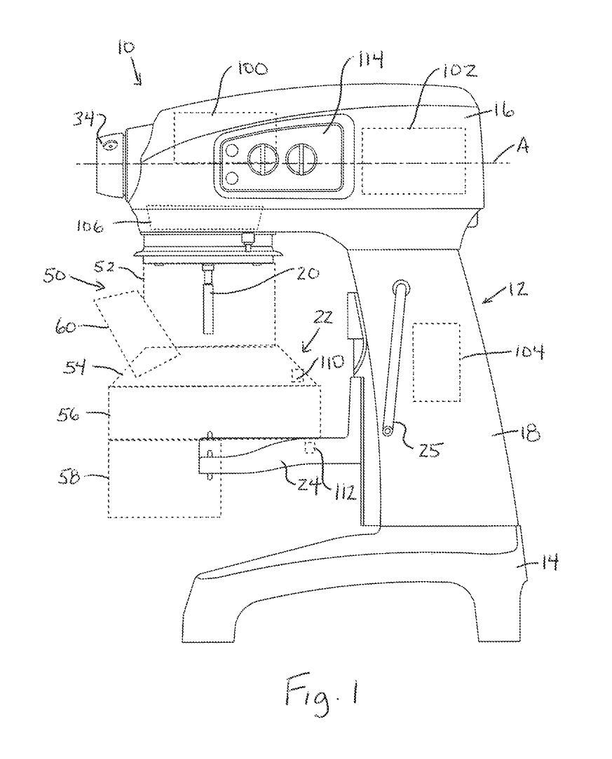

Referring to FIG. 1, an exemplary food processing/preparation machine in the form of a commercial mixing machine 10 is shown. Such a machine typically has a mixer body 12 having a base portion 14, a head portion 16 and a support portion 18 (e.g., in the form of a column) connecting the head and base portions in a vertically, spaced-apart relationship. A front-to-back head portion axis A is shown. An output member 20 (e.g., a shaft for receiving a mixer tool, such as a beater or whip) extends downward from the head portion 16 in a direction toward a bowl receiving location 22 formed between arms 24 of a bowl receiving yoke that can be moved up and down relative to the head portion by rotation of the illustrated handle 25 (or alternatively by a power drive) in order to move a bowl (not shown) up and down. A power take off 34 extends outwardly from a front side of the head portion 16 and may take the form of a protruding hub or boss that is adapted for connection to mixer accessories such as meat grinders, slicers, etc. A microprocessor control board 100 is also shown in schematic form, along with a drive motor 102 and motor control unit 104. Collectively, the control components of the machine may be generally referred to as a controller. As used herein, the term controller is intended to broadly encompass any circuit (e.g., solid state, application specific integrated circuit (ASIC), an electronic circuit, a combinational logic circuit, a field programmable gate array (FPGA)), processor(s) (e.g., shared, dedicated, or group—including hardware or software that executes code), software, firmware and/or other components, or a combination of some or all of the above, that carries out the control functions of the apparatus or the control functions of any component thereof.

The drive system, internal of the machine housing, includes the motor 102 linked to the output member 20 (e.g., through a drive train that includes planetary gearing 106) for effecting rotation of the output member about a first axis and orbiting movement of the output member and first axis about a second axis (e.g., a planetary movement or planetary rotation).

In the machine of FIG. 1, no bowl is shown. Instead, a food processor assembly 50 is driven off the planetary shaft 20 of the mixing machine. The components mount within the confines of the mixer yoke. The assembly includes a main connection housing 52, an intermediate feed section 54, a processing tool section 56 and a eject chute 58. Food is directed down a food chute 60 and then to the processing tool (e.g., cutter, slicer, shredder, etc.) of the attachment section 56, and processed food may exit the food processor via the eject chute 58 substantially parallel with the shaft 20. The processed foods may be collected in pans or bowls located under the food processor assembly and substantially inside the mixer envelope or footprint. The incorporation of the food processor within the mixer envelope frees up kitchen space.

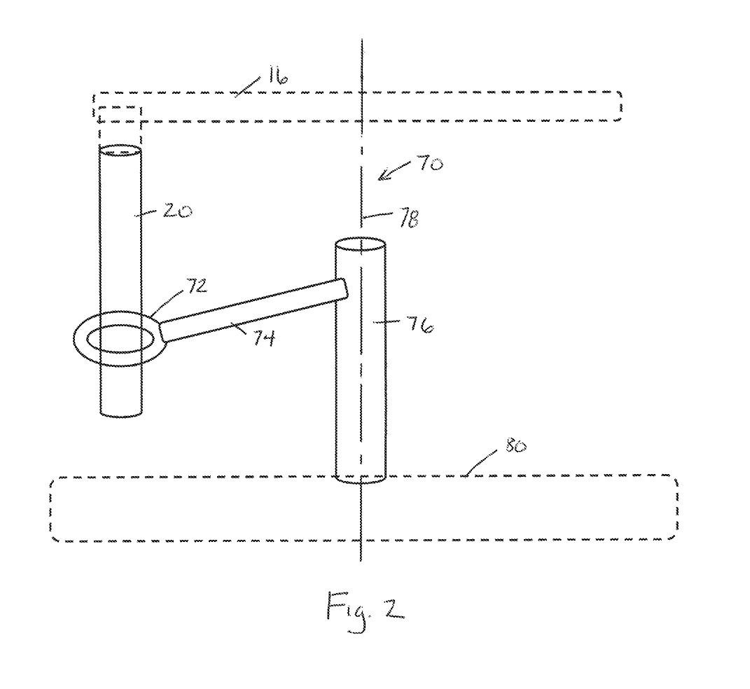

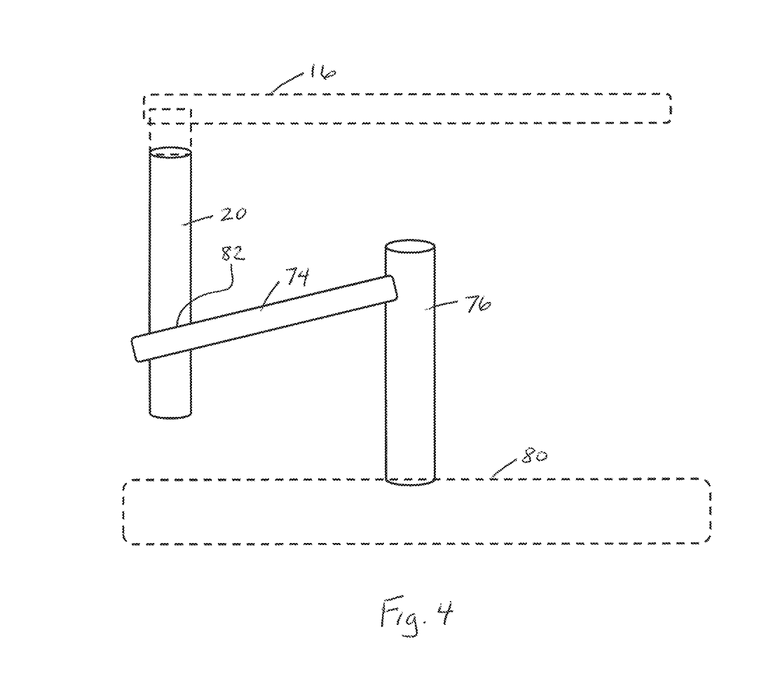

For the purpose of such a machine 10, a drive assembly 70 (shown schematically in FIG. 2) is provided to convert the planetary movement of the output shaft 20 into rotation of the processing tool shaft. In particular, the assembly 70 includes a ring-shaped coupler 72 connected to a crank arm 74 that is fixed to a processing tool shaft 76. The coupler 72 engages the orbiting and rotating output member/shaft 20 that extends down from the underside of the mixer head 16 in a manner that allows the shaft 20 to freely rotate within the coupler. An internal bearing system could be provided on the coupler 72 for such purpose. The orbiting movement of the shaft 20 about axis 78 rotates both the crank arm 74 and the processing tool shaft 76 about the stationary vertical axis 78. A processing component 80 connected to the shaft 76 is rotated by the shaft 76. The processing component may be fixed to the shaft or removably connected to the shaft. The processing component (e.g., shredder plates, slicing plates, or chopping blades, etc.) may be changed out as needed for the particular food processing operation that is required. For this purpose, the processor attachment 56 of the assembly 50 may be removably connected to the processor section 54 and/or to the bowl yoke arms 24. As an alternative to the ring-shaped coupler 72, the coupler could be formed by a drive surface 82 at the end of the crank arm, where the crank arm extends outward from the shaft 76 and into the orbital path of the shaft 20 (see FIG. 4).

In a machine of the foregoing type, or potentially other food machine configurations, the controller keeps track of the state of sharpness for the particular food processing plates, communicates to the user the need to perform a sharpening action, and may also keep track of the sharpening performed on each specific food processing plate.

A food processing tool controller (e.g., part of control board 100) may be configured to keep track of information related to the following variables: type and/or identity of food processing accessory section utilized (RFID, magnetic or other identifiers are provided on the accessories, with one or more sensors 110, 112 on the machine to identify which tool component is attached); number of cycles—number of cumulative cycles—cumulative time of operation for each particular food processing tool or accessory; power consumption profile or load profile—quantity indicative of power consumption profile and power consumption profile change over number of cycles, or number of hours of operation—for each particular food processing tool component 56. Load sensors of the drive control unit 104 may be used for load detection, or separate load sensors could be provided. Sensors 110, 112 could be any of RF code readers, magnetic code readers or optical code readers. The machine controller could also automatically limit the manner in which the drive motor is operable based upon identify of the tool component that is attached (e.g., automatically limit drive motor speed to one or several speeds).

A database of baseline food processing tool component information for each component enables monitoring and assessing profile evolution to determine when sharpening, honing, or adjusting of a specific food processing tool is needed. Separate profile tracking for each food processing tool is performed, and multiple profile sets for each tool may be maintained (e.g., one profile tracking set for a given component section when the tool is used to carry out operation type 1, another profile tracking set for the given tool when the tool is used to carry out operation type 2, etc.). The number of operation types may vary according to multiple factors such as food type, etc. By way of example, Table 1 below is representative of such profile tracking, where specific operations for given tools (e.g., Op7-1 and OP7-2 for tool 1234567) have specific corresponding load profiles (e.g., ProfX1 and ProfX2). Notable from this table is that different tool components could have different numbers of corresponding profiles.

Table 2 below shows an example of a drive motor operating parameter control table that can be used to establish permissible operating parameters for the machine drive motor based upon tool component identity.

TABLE 2
Drive Motor Parameters By Component

| | Motor | Motor | Max |
|---|---|---|---|
| Component ID | Speed Options | Speed Profiles | Load |
| 1234567 | S1, S4 | P1, P2, P5 | L1 |
| 1234568 | S1, S3 | P2, P5 | L2 |

A Human Machine Interface (HMI) 114 is provided on the machine, enabling the controller to display, or otherwise communicate, the state of a specific food processing tool component, such as displaying as a ratio of effort versus power consumption versus output. The HMI communication alerts the food processing machine operator of the need to sharpen or hone a specific food processing tool component, such as based upon time/duration of accessory use, number of cycles of accessory use, speed-weighted time/duration of accessory use (e.g., given that faster speed for a given time period results in more wear), power consumption profile of the accessory versus a threshold or baseline profile, to indicate that a need is present to sharpen.

A sharpening fixture may be attached to the food processing machine, and may be identified or identifiable as such by RFID, Magnetic or optical tracking technology, where the fixture is configured to sharpen or hone a specific food processing tool or accessory.

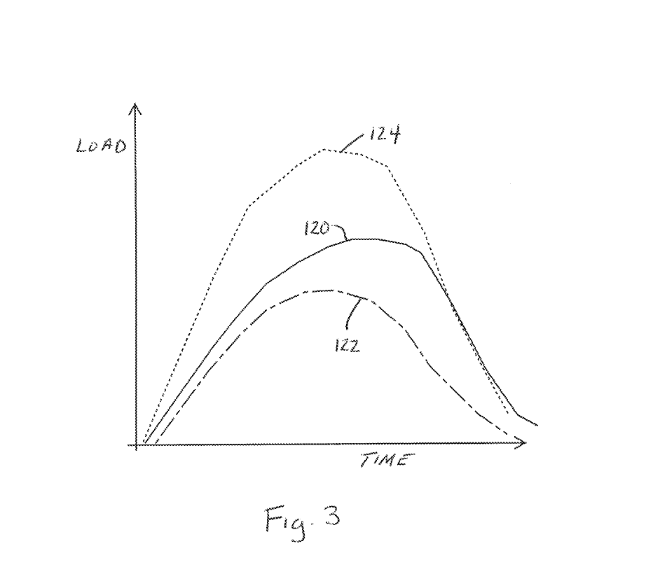

In one implementation, a non-volatile memory of the controller keeps track of the state of sharpening for a particular food processing tool, as well as the evolution of the tool performance over time versus a baseline. For example, per FIG. 3, a baseline load profile 120 for a given component used in a particular operation is shown. If the actual load profile during use is consistent with profile 122, then no sharpening is needed. On the other hand, if the actual load profile during use is consistent with profile 124, then the controller decision-making algorithm determines that sharpening is needed.

As used herein, the terms food processing tool or food processing tool component could refer to a removable tool or tool component alone (e.g., shaft and cutter alone) or a removable tool component in combination with an associated housing about the tool component.

It is to be clearly understood that the above description is intended by way of illustration and example only, is not intended to be taken by way of limitation, and that other changes and modifications are possible. For example, all combinations of the features described in the appended claims are possible.

What is claimed is:

1. A food processing machine, comprising:
a head extending over a bowl receiving location, the head including an output shaft driven in a planetary manner;
a food processing assembly mounted below the head and including a drive assembly for converting planetary motion of the output shaft to a rotational motion of a food processing tool drive shaft about a stationary shaft axis, wherein the food processing assembly includes a food processing tool that can be removed.

2. The food processing machine of claim 1, multiple food processing tools are each removably attachable to the food processing assembly, and a controller is configured to track use of different food processing tools on an individual basis and to determine when each food processing tool component section requires sharpening or honing.

3. The food processing machine of claim 1 wherein each food processing tool includes an identifier thereon and the machine includes at least one sensor for detecting the identifier.

4. The food processing machine of claim 3 wherein each identifier comprises an identification code and the sensor is a code reader.

5. The food processing machine of claim 4 wherein each identification code is one of an RF identification code, a magnetic identification code or an optical identification code and the code reader is one of an RF code reader, a magnetic code reader or an optical code reader.

6. The food processing machine of claim 2 wherein the controller is configured to determine when each food processing tool requires sharpening or honing.

7. The food processing machine of claim 2 wherein the controller is configured to determine when each food processing tool requires sharpening or honing based upon one or more of monitored duration of use, number of cycles of use, speed-weighted duration use, or power consumption profile versus a baseline profile.

8. The food processing machine of claim 7 wherein the machine includes a user interface and the controller is configured to alert a machine operator through the user interface when a given food processing tool requires sharpening or honing.

9. The food processing machine of claim 6 wherein the controller is configured to determine when one or more food processing tools needs to be replaced.

10. The food processing machine of claim 6 wherein the controller is configured to determine when each food processing tool requires sharpening or honing based upon comparison of an actual current power consumption profile versus a baseline profile.

11. The food processing machine of claim 10 wherein the controller is configured to store multiple baseline profiles for at least one food processing tool in memory according to multiple operation types for which the food processing tool is used.

12. The food processing machine of claim 1 wherein the drive assembly includes a coupler engaged with output shaft to permit the output shaft to rotate freely about its moving axis, wherein the coupler is connected to a crank arm that extends to the food processing tool drive shaft.

13. The food processing machine of claim 12 wherein the coupler is ring shaped and receives the output shaft therein.

14. The food processing machine of claim 12 wherein the coupler is formed by a drive surface of the crank arm that intersects an orbital path of the output shaft.

15. The food processing machine of claim 1, further comprising:
a drive motor linked to move the output shaft;
at least one sensor mounted on the machine to detect an identifier of the food processing tool; and
a controller configured to designate one or more operating parameters for the drive motor, based upon the identifier.

16. A food processing machine, comprising:
a head extending over a bowl receiving location, the head including an output shaft driven in a planetary manner;
a drive motor linked to drive the output shaft;
a food processing assembly mounted below the head and including a drive assembly for converting planetary motion of the output shaft to a rotational motion of a drive shaft of a food processing tool about a stationary shaft axis;
at least one sensor mounted on the machine to detect an identifier of the food processing tool; and
a controller configured to designate at least one operating parameter for the drive motor, based upon the identifier.

17. The food processing machine of claim 16 wherein the operating parameter is at least one of a motor speed, a motor speed profile or a maximum permitted motor load.
